(19) United States
(12) Patent Application Publication
(10) Pub. No.: US 2005/0122723 A1
(43) Pub. Date: Jun. 9, 2005

(54) Decorative light strings and repair device

(76) Inventor: W. Richard Frederick, Hardy, VA (US)

Correspondence Address: JENKENS & GILCHRIST, P.C., 225 WEST WASHINGTON, SUITE 2600, CHICAGO, IL, 60606, US

(21) Appl. No.: 10/961,302

(22) Filed: Oct. 8, 2004

Related U.S. Application Data
(63) Continuation of application No. 10/479,010, filed on Nov. 24, 2003.
(63) Continuation of application No. PCT/US02/07609, filed on Mar. 13, 2002.
(63) Continuation-in-part of application No. 09/854,255, filed on May 14, 2001, now abandoned.
(63) Continuation-in-part of application No. 10/041,032, filed on Dec. 28, 2001, now Pat. No. 6,734,678.
(63) Continuation-in-part of application No. 10/068,452, filed on Feb. 6, 2002, now Pat. No. 6,561,673.
(60) Provisional application No. 60/277,346, filed on Mar. 19, 2001.
(60) Provisional application No. 60/277,481, filed on Mar. 20, 2001.
(60) Provisional application No. 60/287,162, filed on Apr. 27, 2001.
(60) Provisional application No. 60/289,865, filed on May 9, 2001.

(51) Int. Cl. F21S 13/14

(52) U.S. Cl. 362/302

(57) ABSTRACT

A string of decorative lights. The string of decorative lights includes a power supply that has an input adapted for connection to a standard residential electrical power outlet. The power supply includes circuitry for converting the standard residential voltage to a low-voltage output. The input is connected through a fusing device to a rectifier circuit. The string of decorative lights also includes a pair of conductors connected to the output of the power supply for supplying the low-voltage output to multiple decorative lights. Multiple lights are also connected to the conductors along the lengths thereof. Each of the lights, or groups of the lights, are connected in parallel across the conductors.

### CROSS-REFERENCE TO RELATED APPLICATIONS

This application is a continuation in part of PCT application PCT/US/02/07609 filed Mar. 13, 2002, claiming priority to U.S. provisional applications 60/277,346 filed Mar. 19, 2001, 60/277,481 filed Mar. 20, 2001, 60/287,162 filed Apr. 27, 2001, 60/289,865 filed May 9, 2001, and U.S. applications Ser. No, 09/854,255 filed May 14, 2001, 10/041,032 filed Dec. 28, 2001 and Ser. No. 10/068,452 filed Feb. 2, 2002.

### FIELD OF THE INVENTION

The present invention relates to decorative lights, including lights for Christmas trees, including pre-strung or “pre-lit” artificial trees.

### SUMMARY OF THE INVENTION

In accordance with one embodiment of the present invention, one or more strings of decorative lights are supplied with power by converting a standard residential electrical voltage to a low-voltage, and supplying the low-voltage to at least one pair of parallel conductors having multiple decorative lights connected to the conductors along the lengths thereof, each of the lights, or groups of the lights, being connected in parallel across the conductors. A string of decorative lights embodying this invention comprises a power supply having an input adapted for connection to a standard residential electrical power outlet, the power supply including circuitry for converting the standard residential voltage to a low-voltage e.g. 12 volts to 30 volts output; a pair of conductors connected to the output of the power supply for supplying the low-voltage output to multiple decorative lights; and multiple lights connected to the conductors along the lengths thereof, each of the lights, or groups of the lights, being connected in parallel across the conductors. The lights preferably require voltages of about 6 volts or less, and are preferably connected in parallel groups of 2 to 5 lights per group with the lights within each group being connected in series with each other.

In one particular embodiment, a supply providing low-voltage DC is used in combination with a string having dual-bulb sockets and associated diode pairs to permit different decorative lighting effects to be achieved by simply reversing the direction of current flow in the string, by changing the orientation of the string plug relative to the power supply.

In another embodiment of the present invention, one or more strings of decorative lights are supplied with power by a power supply including either circuitry for converting the standard residential voltage to one or more DC voltages and circuitry for switching the polarity and/or amplitude of the DC voltage(s), or circuitry for allowing only a predetermined portion of every AC cycle of an AC voltage source to reach the multiple lights.

In another embodiment of the present invention, a string of decorative lights includes a plurality of elongated electrical conductors having multiple electrical lamps inserted into sockets. The multiple electrical lamps and sockets are connected at intervals along the lengths of the conductors. A small compartment is also included and includes a wall forming a first opening adapted to receive in frictional engagement a base of an electrical lamp. The compartment also includes a first member designed to engage a second member on the socket to assist in removing the electrical lamp from the socket.

### BRIEF DESCRIPTION OF THE DRAWINGS

The invention may best be understood by reference to the following description taken in conjunction with the accompanying drawings, in which:

FIG. 1 is a schematic diagram of a string of decorative lights embodying the present invention;

FIG. 2 is a more detailed diagram of the light string shown in FIG. 1;

FIG. 3 is an enlarged and more detailed perspective view of a portion of the light string of FIG. 2;

FIG. 4 is an exploded perspective view of a bulb and socket for use in the light string of FIGS. 1-3;

FIG. 5 is a schematic circuit diagram of a suitable power supply for use in the light string of FIGS. 1-3;

FIG. 6 is a front elevation of a power supply for supplying multiple light strings on a prelit artificial tree;

FIG. 7 is a side elevation of the power supply of FIG. 6;

FIG. 8 is a top plan view of the power supply of FIG. 6;

FIG. 9 is an exploded perspective view of bulbs and a modified socket for use in the light string of FIGS. 1-3;

FIG. 9a is a schematic circuit diagram of a reversible DC power supply for use with the bulbs and modified socket shown in FIG. 9;

FIG. 9b is an exploded perspective view of dual-filament bulbs and sockets;

FIG. 9c is a schematic circuit diagram of a power supply permitting simultaneous control of both filaments in the lights strings of FIG. 9 or FIG. 9b.

FIG. 9d is a schematic circuit diagram of a power supply and filament combination illustrating the operation of the dual filament lamps shown in FIG. 9b.

FIG. 9e is a schematic circuit diagram of a dual-power supply and filament combination according to one embodiment of the present invention;

FIG. 9f is a schematic circuit diagram of a power supply, rectifier bridge, and filament combination according to another embodiment of the present invention;

FIG. 10 is an exploded perspective view of another modified bulb and socket for use in the light string of FIGS. 1-3;

FIG. 11 is an exploded view of the bulb and socket shown in FIG. 10;

FIG. 12 is a schematic circuit diagram of a modified power supply for use with the light string of FIGS. 1-3;

FIG. 13 is a perspective view of a power supply housing mounted on a prelit artificial tree for supplying power to multiple light strings on the tree; and

FIG. 14 is a schematic circuit diagram of a modified power supply for use with the light string of FIGS. 1-3.

### DETAILED DESCRIPTION OF THE ILLUSTRATED EMBODIMENTS

Although the invention will be described next in connection with certain preferred embodiments, it will be understood that the invention is not limited to those particular embodiments. On the contrary, the description of the invention is intended to cover all alternatives, modifications, and equivalent arrangements as may be included within the spirit and scope of the invention as defined by the appended claims.

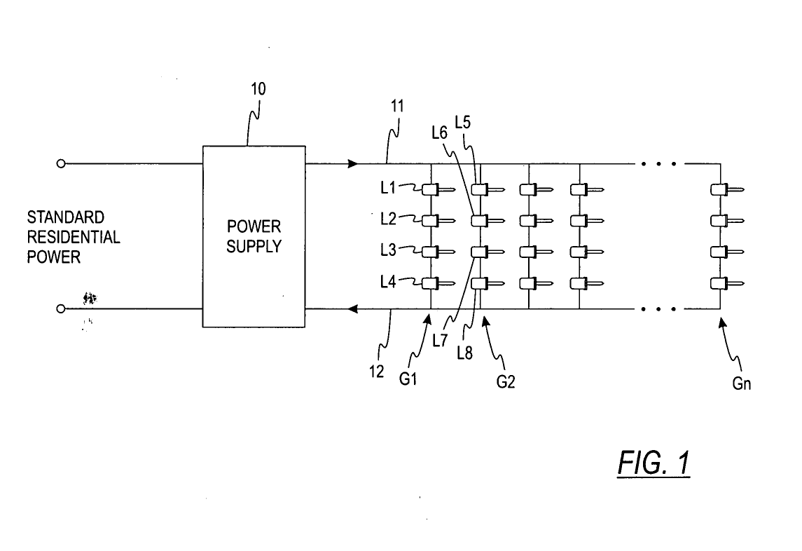

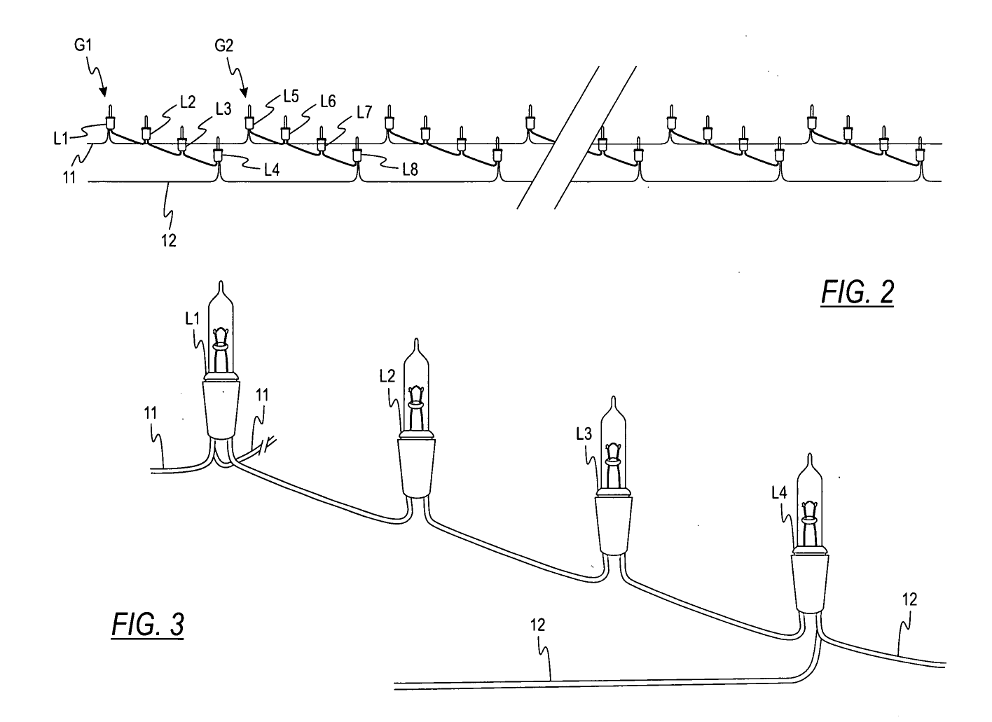

Turning now to the drawings and referring first to FIGS. 1-3, a power supply 10 is connected to a standard residential power outlet that supplies electrical power at a known voltage and frequency. In the United States, the known voltage is 120 volts and the frequency is 60 Hz, whereas in Europe and some other countries the voltage is 220-250 volts and the frequency is 50 Hz. The power supply 10 converts the standard power signal to a 24-volt, 30-KHz AC waveform, which may be a pulse amplitude modulated waveform (PAM), which is supplied to a pair of parallel conductors 11 and 12 that supply power to multiple 6-volt incandescent lights L. A typical light “string” contains 52 lights L.

Multiple groups of the lights L are connected across the two conductors 11 and 12, with the lights within each group being connected in series with each other, and with the light groups in parallel with each other. For example, lights L1-L4 are connected in series to form a first light group G1 connected across the parallel conductors 11 and 12. Lights L5-L8 are connected in series to form a second group G2 connected across the conductors 11 and 12 in parallel with the first group G1, and so on to the last light group Gn.

If one of the bulbs fails, the group of four series-connected lights containing that bulb will be extinguished, but all the other 96 lights in the other groups will remain illuminated because their power-supply circuit is not interrupted by the failed bulb. Thus, the failed bulb can be easily and quickly located and replaced. Moreover, there is no need for shunts to bypass failed bulbs, which is a cost saving in the manufacture of the bulbs. If it is desired to avoid extinguishing all the lights in a series-connected group when one of those lights fails, then the lights may still be provided with shunts that are responsive to the low-voltage output of the power supply. That is, each shunt is inoperative unless and until it is subjected to substantially the full output voltage of the power supply, but when the filament associated with a shunt fails, that shunt is subjected to the full output voltage, which renders that shunt operative to bypass the failed filament. A variety of different shunt structures and materials are well known in the industry, such as those described in U.S. Pat. Nos. 4,340,841 and 4,808,885.

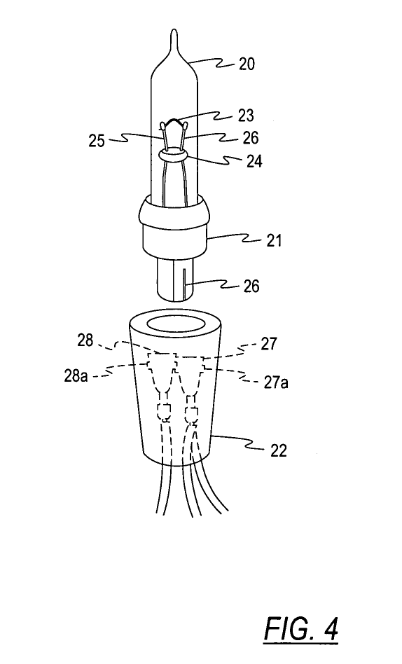

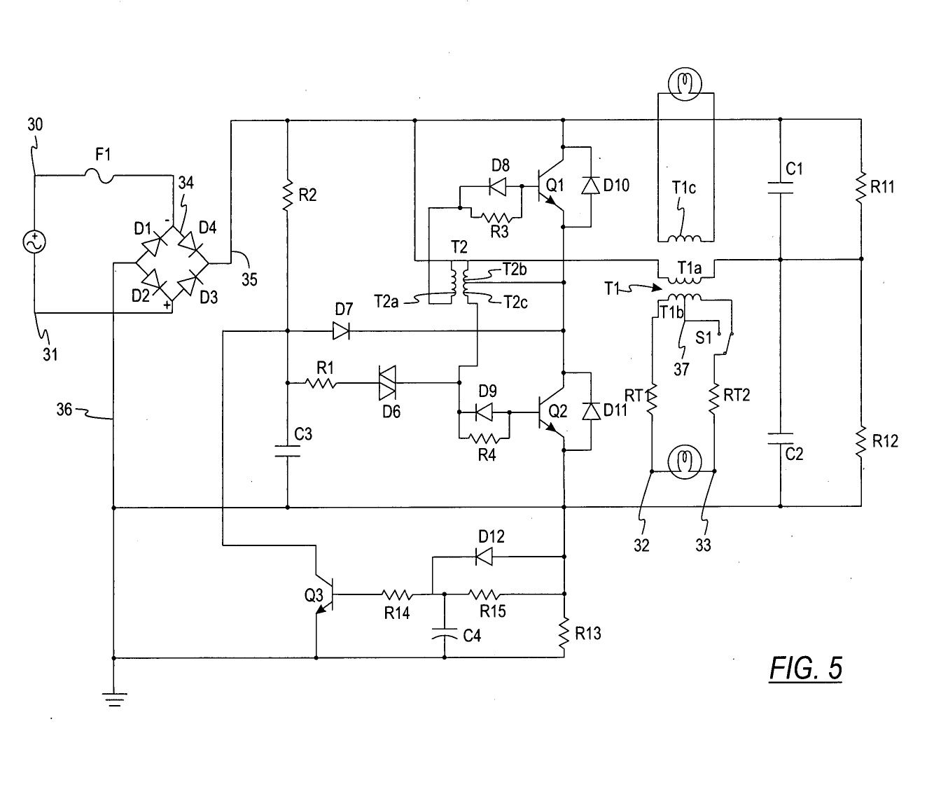

As shown in FIG. 4, each of the individual lights L uses a conventional incandescent bulb 20 attached to a plastic base 21 adapted to be inserted into a plastic socket 22 attached to the wires that supply power to the bulb. Each bulb contains a filament 23 that is held in place by a pair of filament leads 25 and 26 extending downwardly through a glass bead 24 and a central aperture in the base 21. The lower ends of the leads 25, 26 are bent in opposite directions around the lower end of the base 21 and folded against opposite sides of the base to engage mating contacts 27 and 28 in the socket 22. The interior of the socket 22 has a shape complementary to the exterior shape of the lower portion of the bulb base 21 so that the two components fit snugly together.

As shown most clearly in FIG. 4, the contacts 27 and 28 in each bulb base 22 are formed by tabs attached to stripped end portions of the multiple wire segments that connect the lights L in the desired configuration. If a lamp is at one end of a group, these wire segments may include multiple segments of either the conductor 11 or the conductor 12 from FIGS. 1-3. As can be seen in FIG. 4, the connector tabs 27, 28 in each socket 22 are fed up through a hole in the socket and seated in slots formed in the interior surface of the socket on opposite sides of the hole. Prongs 27a and 28a on the sides of the tabs engage the plastic walls of the slots to hold the tabs securely in place within the slots. When the bulb base 21 is inserted into its socket 22, the bent filament leads 25, 26 on opposite sides of the bulb base 21 are pressed into firm contact with the mating tabs 27, 28.

As can be most clearly seen at the lower right-hand corner of FIG. 4, the tab 27 at each end of each series-connected group G is generally connected to two wires, both of which are segments of one of either the conductor 11 or the conductor 12. The other wire, which connects to tab 28, leads to the next light in that particular series-connected group G.

After all the connections have been made, the wires are twisted or wrapped together as in conventional light sets in which all the lights are connected in series.

Turning next to the power supply 10 (shown in FIG. 1), a switching power supply is preferred to minimize size and heat. Power supplies of this type generally use switching technology to make the device smaller. An alternative is a power supply that uses switching technology and pulse width modulation or frequency modulation for output regulation, although this type of power supply is generally more expensive than those using electronic transformers. One suitable electronic transformer is available from ELCO Lighting of Los Angeles, Calif., Cat. No. ETR150, which converts a 120-volt, 60-Hz input into a 12-volt, 30-KHz output.

FIG. 5 is a generalized schematic diagram of a power supply for converting a standard 120-volt, 60-Hz input at terminals 30 and 31 into a 24-volt AC output at terminals 32 and 33. It will be understood that devices for supplying low-voltage, high-frequency signals are well known and vary to some degree depending on the output wattage range of the supply, and the particular design of the device is not part of the present invention. FIG. 5 illustrates a standard self-oscillating half-bridge circuit in which two transistors Q1 and Q2 and parallel diodes D10 and D11 form the active side of the bridge, and two capacitors C1 and C2 and parallel resistors R11 and R12 form the passive side.

The AC input from terminals 30 and 31 is supplied through a fusing device (in this case fuse F1) to a rectifier circuit, such as diode bridge 34, consisting of diodes D1-D4 to produce a full-wave rectified output across busses 35 and 36 leading to the capacitors C1 and C2, transistor Q1, and transistor Q2 (through R13). The capacitors C1, C2 form a voltage divider, and one end of the primary winding T1a of an output transformer T1 is connected to a point between the two capacitors. The secondary winding T1b of the output transformer is connected through RT1, RT2, and S1 to the output terminals 32 and 33, which are typically part of a socket for receiving one or more plugs on the ends of light strings. The resistors R11 and R12 are connected in parallel with the capacitors C1 and C2 to equalize the voltages across the two capacitors, and also to provide a current bleed-off path for the capacitors in the event of a malfunction.

When power is supplied to the circuit, a capacitor C3 begins charging to the input voltage through a resistor R2. A diac D6 and a current-limiting resistor R1 are connected in series from a point between the capacitor C3 and the resistor R2 to the base-drive circuitry of the transistor Q2. When the capacitor C3 charges to the trigger voltage of the diac D6, the capacitor C3 discharges, supplying current to the base of the transistor Q2 and turning on that transistor. This action is required to start the switching process. During normal operation, diode D7 prevents the capacitor C3 from acquiring sufficient voltage to trigger diac D6 by repeatedly discharging capacitor C3 via transistor Q2. A resistor R2 limits the current from the bus 35. Resistors R3 and R4, connected to the bases of the respective transistors Q1 and Q2 stabilize the biases, and diodes D8 and D9 in parallel with the respective resistors R3 and R4 provide for fast turn off.

Self-oscillation of the illustrative circuit is provided by an oscillator transformer T2 having a saturable core. A ferrite core having a B/H curve as square as possible is preferred to provide a reliable saturation point. The number of turns in the primary and secondary windings T2b and T2a of the transformer T2 are selected to force the operating gain of the transistors Q1 and Q2, based on the following equation:
Nₚ*I_{P}=Nₛ*Iₛ
where Nₚ is the number of turns in the primary winding T2b, Nₛ is the number of turns in the secondary winding T2a, Iₚ is the peak collector current, and Iₛ is the base current. Suitable values for Nₚ and Nₛ are 1 and 3, respectively, and assuming a one-volt supply across the primary winding Nₚ, the forced gain is 3. The nominal collector current I_{c} is:
I_{c}=(Pₒᵤₜ/η)*(2NVₗᵢₙₑ)
where I_{c} and Vₗᵢₙₑ are RMS values, η is the efficiency of the output transformer T1, and Pₒᵤₜ is the average output power.

The saturable transformer T2 determines the oscillation frequency F according to the following equation:
F=(Vₚ*10⁴)/(4*Bₛ* A*Nₚ)
where F is the chopper frequency, Vₚ is the voltage across the primary winding T2b of the oscillator transformer T2 in volts, Bₛ is the core saturation flux in Tesla, and A is the core cross section in cm².

The output transformer T1 has a non-saturable core with a ratio Nₚ/Nₛ to meet the output requirements, such as 24 volts (RMS). It must also meet the power requirements so that it may operate efficiently and safely. The peak voltage Vₚ(pri) across the primary winding T1a is one half of the peak rectified voltage Vₚₑₐₖ at bus 35.
Vₚ(pri)=Vₚₑₐₖ/2=(120*1.414)/2=85 volts

The desired 24-volt output translates to:
Vₚ(sec)=24*1.414=33.9 volts

Thus, the required ratio of turns in the primary and secondary windings of the transformer T1 is 85/33.9 or 2.5/1.

A third winding T1c with a turns ratio of 10/1 with respect to the primary winding provides a nominal 6-volt output for a bulb checker, described below.

The illustrative circuit also includes a light dimming feature. Thus, a switch Si permits the output from the secondary winding T1b to be taken across all the turns of that winding or across only a portion of the turns, from a center tap 37. A pair of thermistors RT1 and RT2 are provided in the two leads from the secondary winding T1b to the terminals 32 and 33 to limit inrush current during startup.

To automatically shut down the circuit in the event of a short circuit across the output terminals 32 and 33, a transistor Q3 is connected to ground from a point between a diac D6 and a diode D9. The transistor Q3 is normally off, but is turned on in response to a current level through resistor R 3 that indicates a short circuit. The resistor R13 is connected in series with the emitter-collector circuits of the two transistors Q1 and Q2, and is connected to the base of the transistor Q3 via resistors R14 and R15, a diode D12, and capacitor C4. The current in the emitter-collector circuit of transistors Q1 and Q2 rises rapidly in the event of a short circuit across the output terminals 32, 33. When this current flow through resistor R13 rises to a level that causes the diode D12 to conduct, the transistor Q3 is turned on, thereby disabling the entire power supply circuit.

The light string is preferably designed so that the load on the power supply remains fixed so that there is no need to include voltage-control circuitry in the power supply to maintain a constant voltage with variable loads. For example, the light string preferably does not include a plug or receptacle to permit multiple strings to be connected together in series, end-to-end. Multiple strings may be supplied from a single power supply by simply connecting each string directly to the power supply output via parallel outlet sockets. Extra lengths of wire may be provided between the power supply and the first light group of each string to permit different strings to be located on different portions of a tree. Because ripple is insignificant in decorative lighting applications, circuitry to eliminate or control such fluctuations is not necessary, thereby reducing the size and cost of the power supply.

The low-voltage output of the power supply may have a voltage level other than 24 volts, but it is preferably no greater than the 42.4 peak voltage specified in the UL standard UL1950, SELV (Safe Extra-Low Voltage). With a 30-volt rms supply, for example, 10-volt lights may be used in groups of three, or 6-volt lights may be used in groups of five. Other suitable supply voltages are 6 and 12 volts, although the number of lights should be reduced when these lower output voltages are used.

The power supply may produce either a DC output or low-voltage AC outputs. The frequency of a low-voltage AC output is preferably in the range from about 10 KHz to about 150 KHz within a 60 Hz envelope to permit the use of relatively small and low-cost transformers.

The voltage across each light must be kept low to minimize the complexity and cost of the light bulb and its socket. Six-volt bulbs are currently in mass production and can be purchased at a low cost per bulb, especially in large numbers. These bulbs are small and simple to install, and the low voltage permits the use of thin wire and inexpensive sockets, as well as minimizing the current in the main conductors. In the illustrative light string of FIG. 1 with a 24-volt supply and four lights per group, the voltage available for each light is 6 volts. Consequently, the bulbs can be the simple and inexpensive bulbs that are mass produced for conventional Christmas light strings using series-connected lights. Similarly, the simple and inexpensive sockets used in such conventional Christmas light strings can also be used. Simple crimped electrical contacts may be provided at regular intervals along the lengths of the parallel conductors 11 and 12 for connection to the end sockets in each group of four lights. The maximum current level is only about 2 amperes in a 100-light string using four 6-volt lights per group and a 24-volt supply, and thus the two conductors 11 and 12 can also be light, thin, and inexpensive.

Light strings embodying the present invention are particularly useful when used to pre-string artificial trees, such as Christmas trees. Such trees can contain well over 1000 lights and can cost several hundred dollars (US) at the retail level. When a single light and its shunt fail in a series light string, the lights in an entire section of the tree can be extinguished, causing customer dissatisfaction and often return of the tree for repair or replacement pursuant to a warranty claim. When the artificial tree is made in sections that are assembled by the consumer, only the malfunctioning section need be returned, but the cost to the warrantor is nevertheless substantial. With the light string of the present invention, however, the only lights that are extinguished when a single light fails are the lights in the same series-connected group as the failed light. Since this group includes only a few lights, typically 2 to 5 lights, the failed bulb can be easily located and replaced.

When pre-stringing artificial trees, the use of a single low-voltage power supply for multiple strings is particularly advantageous because it permits several hundred lights to be powered by a single supply. This greatly reduces the cost of the power supply per string, or per light, and permits an entire tree to be illuminated with only a few power supplies, or even a single power supply, depending on the number of lights applied to the tree.

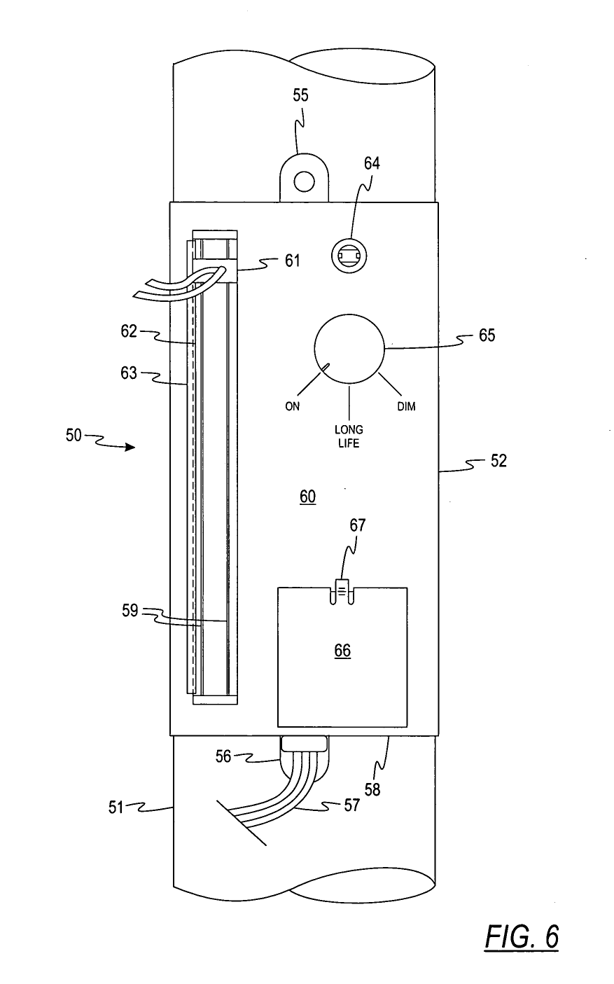

FIGS. 6-8 illustrate a single power supply 50 for supplying power to a multiplicity of light strings on a prelit artificial tree having a hollow artificial trunk 51. The power supply is contained in a housing 52 having a concave recess 53 in its rear wall 54 to mate with the outer surface of the artificial trunk 51. A pair of apertured mounting tabs 55 and 56 are provided at opposite ends of the rear wall 54 to permit the power supply to be fastened to the trunk 51 with a pair of screws. The power input to the supply 50 is provided by a conventional three-conductor cord 57 that enters the housing through the bottom wall 58. The free end of the cord 57 terminates in a standard three-prong plug.

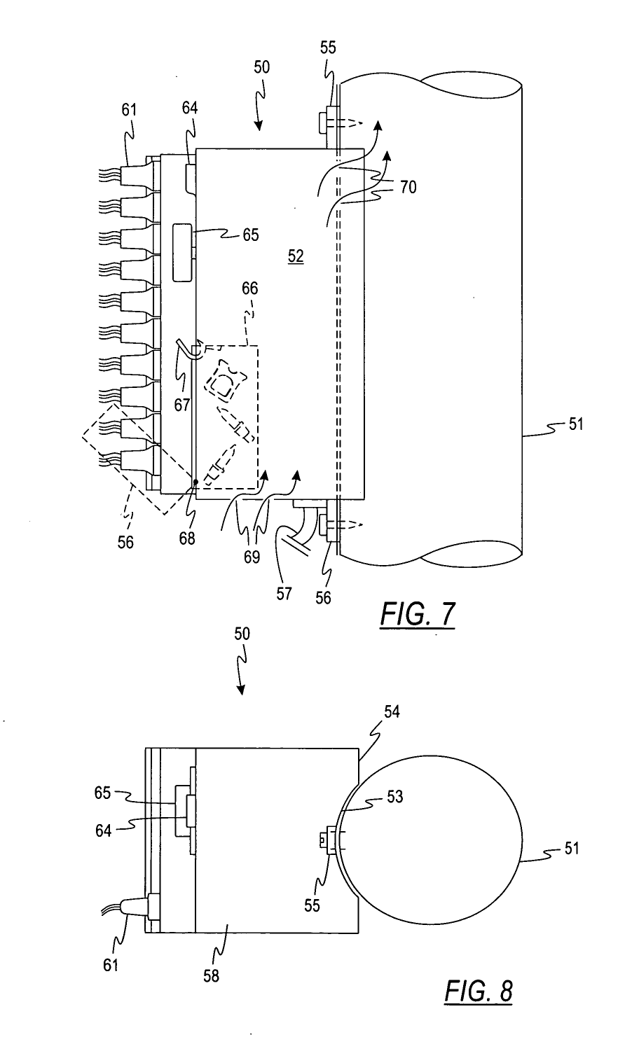

The power output of the supply 50 is accessible from a terminal strip 59 mounted in a vertically elongated slot in the front wall 60 of the housing 52. This terminal strip 59 can receive a multiplicity of plugs 61 on the ends of a multiplicity of different light strings, as illustrated in FIG. 7. Thus, if each light string contains 100 lights and the terminal strip can receive ten plugs, the power supply can accommodate a total of 1000 lights for a given tree. Each plug 61 is designed to fit the terminal strip 59 but not standard electrical outlets, to avoid accidental attachment of the low-voltage light string to a 120-volt power source. A latch 62 extends along one elongated edge of the terminal strip 59 to engage each plug 61 as it is inserted into the strip, to hold the plugs in place. When it is desired to remove one of the plugs 61, a release tab 63 is pressed to tilt the latch enough to release the plug.

The front wall of the power supply 50 also includes a bulb-testing socket 64 containing a pair of electrical contacts positioned to make contact with the exposed filament leads on a 6-volt bulb when it is inserted into the socket 64. The contacts in the socket 64 are connected to a 6-volt power source derived from the power-supply circuit within the housing 52, so that a good bulb will be illuminated when inserted into the socket 64.

If desired, dimmer, flicker, long-life and other operating modes can be provided by the addition of minor circuitry to the power supply. In the illustrative power supply 50, a selector switch 65 is provided on the front of the housing 52 to permit manual selection of such optional modes.

The front wall 60 of the housing 52 further includes an integrated storage compartment 66 for storage of spare parts such as bulbs, tools and/or fuses. This storage compartment 66 can be molded as a single unit that can be simply pressed into place between flanges extending inwardly from the edges of an aperture in the front wall 60 of the housing 52. The flange on the top edge of the aperture engages a slightly flexible latch 67 formed as an integral part of the upper front corner of the storage compartment 66. The lower front corner of the compartment and the adjacent flanges form detents 68 that function as pivot points to allow the storage compartment 66 to be pivoted in and out of the housing 52, as illustrated in FIG. 7, exposing the open upper end of the storage compartment.

As can be seen in FIGS. 7 and 8, the bottom and rear walls 58 and 54 of the housing 52 are preferably provided with respective holes 69 and 70 that allow air to flow by convection through the housing to provide airflow desired of the circuit elements within the housing.

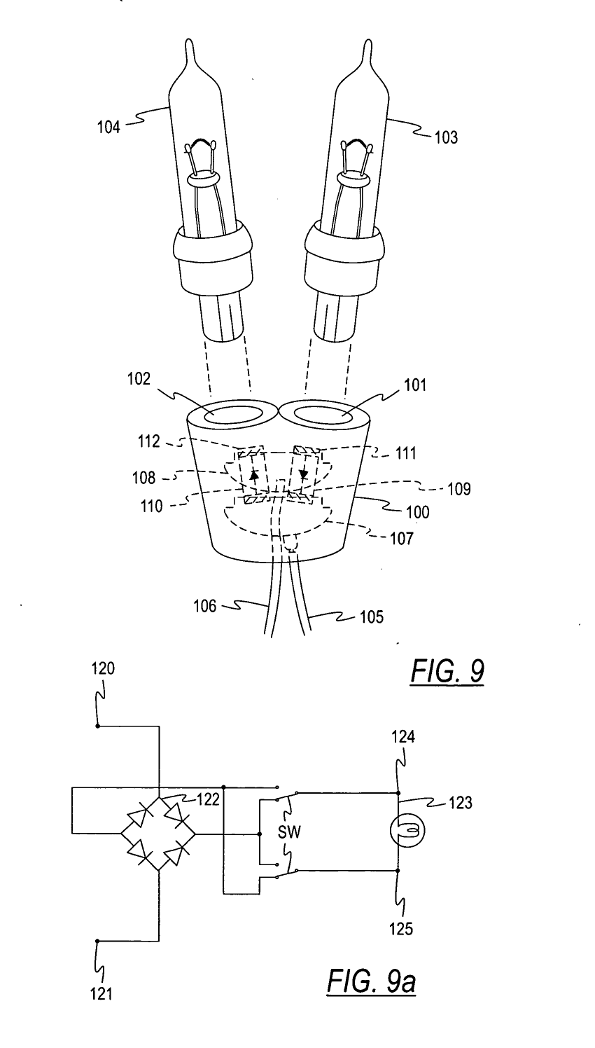

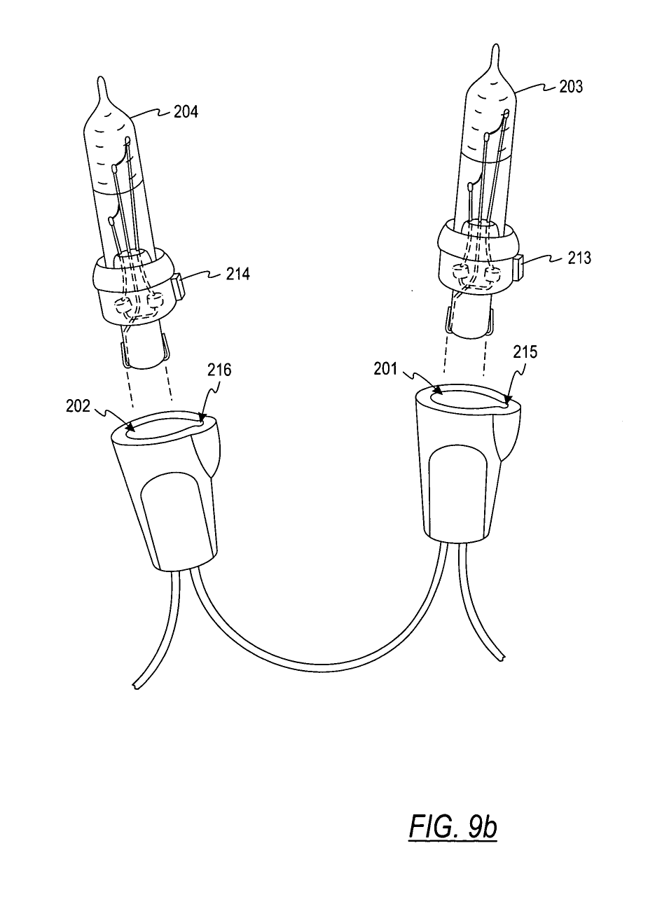

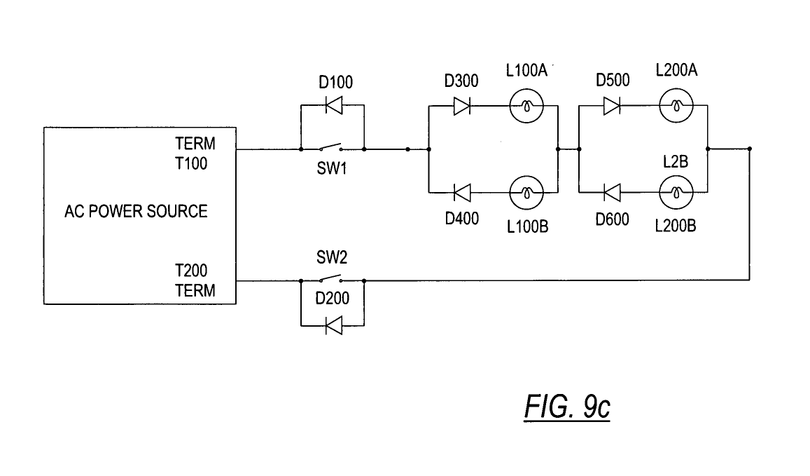

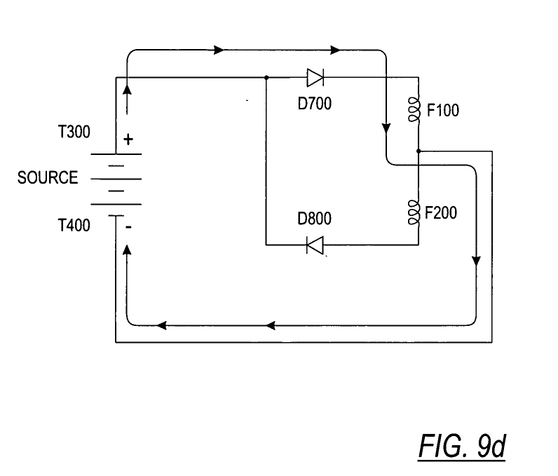

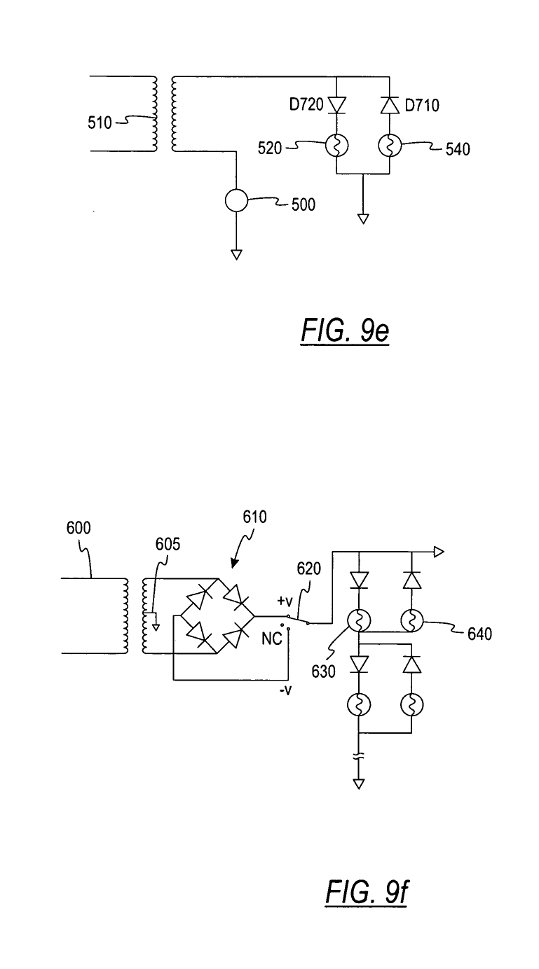

FIG. 9 illustrates a modified bulb-socket construction for use with a low-voltage DC power supply. A DC power supply may be the same device described above with the addition of a full-wave rectifier at the output to convert the low-voltage, high-frequency voltage to a low-voltage, DC voltage. The plug on the light string to be connected to the DC power supply is reversible so that the plug may be inserted into the socket of the power supply in either of two orientations, which will cause the DC current to flow through the light string in either of two directions. As will be described in more detail below, the direction of the current flow determines which of two bulbs in each of the multiple sockets along the length of the string are illuminated. This permits different decorative effects to be achieved with the same string by simply reversing the orientation of the string plug relative to the power-supply socket. For example, the bulbs illuminated by current flow in one direction may be clear bulbs, while the bulbs illuminated by current flow in the opposite direction may be colored and/or flashing bulbs.

As can be seen in FIG. 9, each socket 100 forms receptacles 101 and 102 for two different bulbs 103 and 104, respectively. For example, bulb 103 may be clear and bulb 104 colored. Power is delivered to both receptacles 101 and 102 by the same pair of wires 105 and 106, but the connector tabs 107 and 108 attached to the wires have increased widths to permit either an electrical connection to one of the exposed filament leads on the base of each bulb or to permit the diodes discussed below to be mounted. The rear connector tab 108 makes direct contact with one of the filament leads on the base of each bulb. The front connector tab 107 carries a pair of inexpensive, oppositely poled, surface-mount diodes 109 and 110 having metallized contact surfaces III and 112 at their upper ends. Each of the metallized contact surfaces 111 and 112 makes contact with a filament lead on only one of the bulb bases, so that each diode 109 and 110 is connected to only one bulb. Because a diode conducts current in only one direction, and the two diodes are poled in opposite directions, the DC current supplied to the socket 100 will flow through only one of the two bulbs 103 or 104, depending upon the direction of the current flow, which in turn depends upon the orientation of the string plug relative to the power-supply socket.

As shown in FIG. 9, the two bulbs 103 and 104 preferably diverge from each other to reduce reflections from the non-illuminated bulb in each pair. If desired, a non-reflective barrier may be provided between the two bulbs.

A modified construction is to provide only a single pair of diodes for each of the parallel groups of lights. The diodes are provided at one end of each parallel group, with two separate wires connecting each diode to one of the two bulbs in each socket in that group. Another modified construction uses only a single bulb in each socket, with each bulb having two filaments and two diodes integrated into the base of the bulb for controlling which filament receives power. FIG. 9b shows a typical example of such a construction. As shown in FIG. 9b, each bulb 203, 204 and socket 201, 202 include a key 213, 214 and a slot 215, 216 to insure bulb insertion in only one direction. This guarantees that the same filament in each bulb will glow in response to current in a particular direction, which is desirable for producing a uniform effect. The two filaments are spaced from each other along the axis of the bulb, and one end portion of the bulb is colored so that illumination of the filament within that portion of the bulb produces a colored light, while illumination of the other filament produces a clear light. Alternatively, the opposite end portions of the bulb can both be colored, but of two different colors.

FIG. 9a is a diagram of a circuit for reversing the polarity of a DC power supply. The standard AC power source is connected across a pair of input terminals 120 and 121 and full-wave rectified by a rectifier circuit, such as diode bridge 122, as described above. The rectified output of the bridge 122 is supplied to the light string 123 connected to output terminals 124 and 125. Between the bridge 122 and the terminals 124, 125, a dual pole switch SW can change the direction of current flow so that the polarity of the terminals 124 and 125 is reversed.

In some cases, light strings using the bulb and socket configurations of FIGS. 9 and 9b would make use of the power supply described in FIG. 9a. The dual pole switch SW causes one of the lamps or filaments to light, but not the other. In other words, one of the two lamps in the dual socket of FIG. 9 (or one of the dual filaments of FIG. 9b) might be lit at any given time, but not both.

Other known power supplies may be used such that power is supplied to both lamps (or filaments), causing both lamps or filaments to be lit simultaneously. These circuits all take advantage of the thermal time lag in the filaments of the lamps. One method drives the light string with an AC current. This causes both of the lamps or filaments to glow with equal intensity. A second DC current (or lower frequency AC current) is added to the original AC current. The combined AC and DC currents cause one lamp or filament to glow brighter, while the second becomes dimmer. By adjusting the amplitudes of the AC and DC currents, independent control can be obtained over each lamp in FIG. 9 (or filament in FIG. 9b). If the second source were a slowly varying AC source instead of DC, the lamps could be made to fade from one into another and back at the frequency of that source.

Another approach is to rectify an AC power source to generate one or more DC sources. The DC source (or sources) is then electronically switched at a fast rate, supplying positive current, negative current, and zero current to the light string. By controlling the length of time a switch is ‘on’ or ‘off,’ independent control can be obtained over the bulbs or filaments. This approach would also include circuits using SCRs, TRIACs, transistors, or similar devices, triggered asymmetrically on positive and negative half cycles of AC input current.

FIG. 9c is an example of the above approach. Electronic switches SW1 and SW2 can include SCRs, TRIACs, transistors and/or similar devices, as well as other appropriate control circuitry. If terminal T100 is positive and terminal T200 is negative, current flows from T100 to SW1. From SW1, the current then flows through diode D300 into filament L100a, then to diode D500, filament L200a, and back to switch SW2. Switch SW2 is turned off at this time, so the current goes through diode D200 and returns to terminal T200. The brightness of filaments L100a and L200a is controlled by the percentage of time that switch SW1 remains ‘on’ during this half cycle. When terminal T200 becomes positive and terminal T100 is negative, the current flows from terminal T200 to switch SW2, to filament L200b, to diode D600, to filament L100b, to diodes D400 and D100, and then back to terminal T100. Switch SW1 is off at this time, and switch SW2 controls the brightness of filaments L100b and L200b. Switching occurs at such a high rate that the filaments L100a, L100b, L200a, and L200b, do not have time to cool. Thus, both lamps glow. Relative brightness between the lamps and overall brightness are thus controlled by the amount of time switches SW1 and SW2 are ‘on’ during their respective half cycles.

These methods are described for illustrative purposes only. There are numerous other well-known methods that can be used. These methods are beneficial effects. For example, if one lamp or filament were colored red and the other were white, it would be possible to cause the lamps to fade from white to red every 10 seconds or so. By fading from one bulb into the other at a faster rate, it is possible to achieve a shimmering effect wherein the lamps appear to be in motion. The lamps could also be made to change color or brightness in time with music or other special effects.

Turning now to FIG. 9d, a schematic of a light string in combination with a power source having terminals T300 and T400 is shown. In this embodiment, if the current is flowing from terminal T300 to T400, the current flows through diode D700, the top filament F100 to T400, thus only lighting the top filament F100. If the direction of the current is reversed, so that it travels from terminal T400 to terminal T300, the current flows through the bottom filament F200, through the diode D800 and to terminal T300. The advantage of this design, is that the diodes D700 and D800 are part of the base of the light string, and not included in the power supply. This allows the light string to operate with fewer wires on the outside, which is more aesthetically pleasing and cheaper to manufacture.

FIG. 9e illustrates an embodiment of the present invention where two power sources are used. In this embodiment, power is supplied by both a DC power supply 500 and an AC power supply 510. Depending upon the direction of the current flow, the current passes through either diode 720 to the bulb or filament 520 or through diode 710 to the bulb or filament 540. By varying the amplitude of each supply relative to the other, the individual brightness of each bulb (520 or 540) can be controlled at will. This is just one example of using multiple power supplies. Other known methods may also be utilized.

FIG. 9f illustrates another embodiment of the present invention for manipulating current flow. In this embodiment, an AC power supply 600 produces a low voltage AC output. A center tap 605 is attached to the power supply 600. A full wave rectifier bridge 610 is connected to the AC power supply 600 and generates two DC sources. One is positive and the other negative. A single pole triple throw electronic switch 620 switches between the positive DC source, the negative DC source, or no source (position NC) at all. This then controls which of the two bulbs or filaments 630, 640, if either, receive any current. By switching at a sufficiently fast rate, and controlling the amount of time switch 620 remains closed in each position, the individual brightness of each bulb (630 or 640) can be controlled at will.

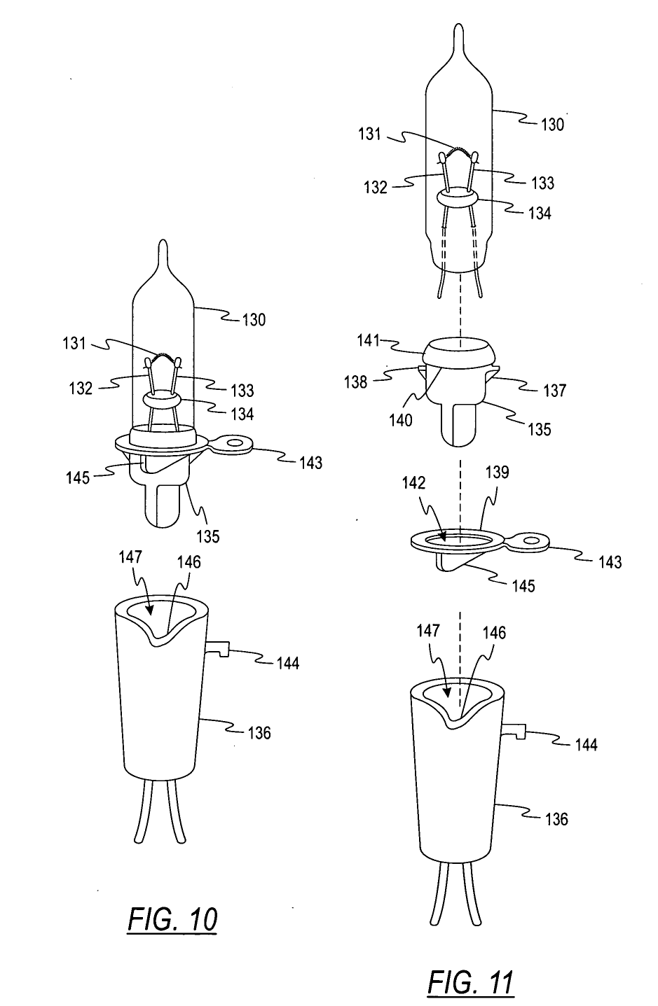

FIGS. 10 and 11 illustrate a modified bulb base and socket construction that facilitates the replacement of a failed bulb. The bulb 130 in FIGS. 10 and 11 has the same construction described above, including a filament 131 and a pair of filament leads 132 and 133 held in place by a glass bead 134. The leads 132 and 133 extend downwardly through a molded plastic base 135 that fits into a complementary socket 136. In this modified embodiment, the bulb base 135 includes a pair of diametrically opposed lugs 137 and 138 that support a bulb-removal ring 139 between the top surfaces of the lugs and the underside 140 of the flange 141 of the base 135. The central opening 142 of the ring 139 is dimensioned to have a diameter just slightly smaller than that of the flange 141 so that the ring can be forced upwardly over the lugs 137, 138 until the ring 139 snaps over the top surfaces of the lugs, adjacent the underside of the flange 141. The ring 139 is then captured on the base 135, but can still rotate relative to the base.

To hold the bulb base 135 in the socket 136, the ring 139 forms a hinged, apertured tab 143 that can be bent downwardly to fit over a latching element 144 formed on the outer surface of the socket 136. When the bulb fails, the tab 143 is pulled downwardly and away from the socket 136 to release it from the socket 136, and then the tab 143 is used to rotate the ring 139 to assist in removing the bulb and its base 135 from the socket 136. As the ring 139 is rotated, a descending ramp 145 molded as an integral part of the ring engages a ramp 146 formed by a complementary notch 147 in the upper end of the socket 136. When the bulb base 135 and the socket are initially assembled, the ramp 145 on the ring 139 nests in the complementary notch 147. But when the ring 139 is rotated relative to the socket 136, the engagement of the two ramps 145 and 146 forces the two parts away from each other, thereby lifting the bulb base 135 out of the socket 136.

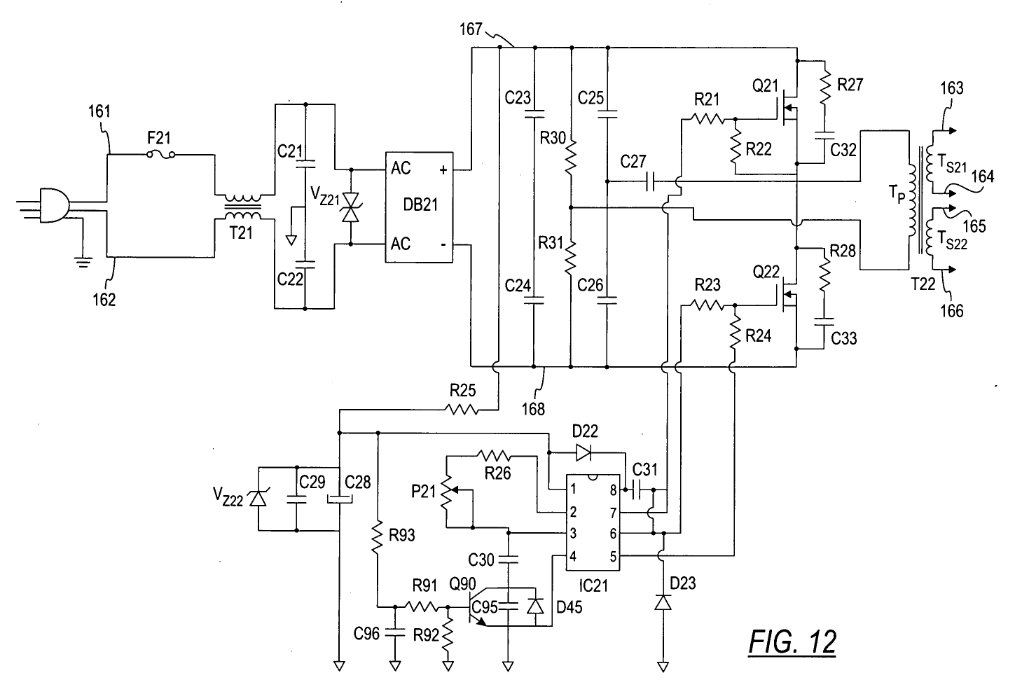

FIG. 12 is a generalized schematic diagram of a power supply for converting a standard 120-volt, 60-Hz input at terminals 161, 162 into a 24-volt AC output at terminals 163, 164 and 165, 166. This circuit uses a switching power supply to deliver a low-voltage, high-frequency AC signal while also providing the following features for the light strings:
continuous dimming capability from very low light level to full light level,
multi-level dimming capability,
energy-saving and minimum-light-setting features,
soft-start feature to increase the lamp life,
soft start feature to reduce inrush current in the circuit, and
low cost with multi-feature lighting.

The AC input from the terminals 161, 162 is supplied through a fusing device, shown as fuse F21, to a diode bridge DB21 consisting of four diodes to produce a full-wave rectified output across buses 167 and 168, leading to a pair of capacitors C23 and C24 and a corresponding pair of transistors Q21 and Q22 forming a half bridge. The input to the diode bridge DB21 includes inductor T21, a MOV (metal oxide varistor) or dual zener diode V_{Z21} and a pair of capacitors C21 and C22 which are part of the radio frequency interference and line noise filtering circuitry. Capacitors C25 and C26 are connected in parallel with capacitors C23 and C24, respectively, to provide increased ripple current rating and high-frequency performance. The capacitors C23 and C24 may be electrolytic capacitors while capacitors C25 and C26 are film-type capacitors offering high-frequency characteristics to the parallel combination. A pair of resistors R30 and R31 are connected in parallel with the capacitors C23 and C24, respectively, to equalize the voltages across the two capacitors, and also to provide a current bleed-off path for the capacitors in the event of a malfunction.

The capacitors C23, C24 form a voltage divider, and one end of the primary winding T_{P} of an output transformer T22 is connected to a point between the two capacitors. The secondary windings T_{S21} and T_{S22} of the transformer T22 are connected to the output terminals 163, 164 and 165, 166, which are typically part of a socket for receiving one or more plugs on the ends of light strings. A capacitor C27 is connected in parallel with the primary winding T_{P} and acts as a snubber across the transformer T22 to reduce voltage ringing.

An integrated circuit driver IC21, such as an IR2153 driver available from International Rectifier, drives the half bridge MOSFET transistors Q21 and Q22. The power supply for the driver IC21 is derived from the DC bus through a resistor R25 and a parallel combination of capacitors C28 and C29. The capacitor C28 may be an electrolytic or an a film capacitor, and the capacitor C29 is preferably a film-type capacitor offering a high-frequency de-coupling characteristic to the driver IC21. A zener diode V_{Z22} clamps the voltage at V_{CC} input pin 1 of IC21 to ensure a safe operating limit. The zener diode V_{Z22} along with the resistor R25 provide a regulated power supply for the driver IC21. A diode D22 and a capacitor C31 provide a boot-strap mechanism for power storage to turn on the MOSFET Q21 of the half bridge.

The frequency of oscillation of the MOSFET driver is determined by the total resistance connected across pins 2 and 3 of the driver IC21 together with the capacitance from pin 3 to ground. The two outputs of IC21, pins 7 and 5, are connected to the gates of the MOSFETs Q21 and Q22. A resistor R21 limits the gate current of the MOSFET Q21, while R24 limits the gate current of MOSFET Q22. A pair of resistors R22 and R23 are connected across the MOSFETs Q21 and Q22 to reduce noise sensitivity to avoid any spurious turn-on of the MOSFETs. Resistor/capacitor combinations R27/C32 and R28/C33 are tied across the two MOSFETs Q21 and Q22 as snubbers to quench transient voltage surges at the turn-off of these transistors.

When power is applied to the circuit, the voltage developed on the bus 167 causes voltage to be applied to the IC21's V_{CC} input. This causes the driver IC21 to start oscillating and start driving the half-bridge transistors Q21 and Q22 alternately. This applies voltage across the primary winding T_{P} of the transformer T22, which in turn applies voltage across the secondary windings T_{S21} and T_{S22} of the transformer, which is applied to the load.

The rectified output of the DC bus 167 is applied is applied to the Vcc pin 1 of the driver IC21 through a resistor R25. A zener diode V_{Z22} and capacitors C28 and C29, connected between the Vcc pin 1 and ground, provide decoupling and voltage regulation for the driver IC21. The two outputs of IC21 at pins 7 and 5, provide drive to the gates of the MOSFETs Q21 and Q22.

The RMS output voltage can be varied by controlling the on/off ratio of the pulse width applied to the primary of the transformer T22. A limited dimming control can be achieved by varying the frequency of the oscillation signal from the integrated circuit IC21. The output voltage is controlled by the potentiometer P21 connected to the integrated circuit, which permits the user to adjust the light output to the desired level.

The dimming feature can be used to provide different fixed light levels, such as a low light output, an energy-saving output, or a full-light output. These three light levels can be achieved by use of three fixed resistors in place of the potentiometer P21. The three resistor settings can be selected by use of a three-position switch. A low-light output corresponds to a minimum output voltage, and a full-light output corresponds to maximum output voltage. An energy-saving output corresponds to an intermediate light level such as a 75% light output.

The bulb life can be extended by soft starting the driver IC21, so that the IC starts with minimum light output and slowly ramps up to the full or desired light level. At the time of start, the bulbs in the light string are normally cold, and the cold resistance of the bulbs is very low. The cold resistance of a bulb is typically ten times lower than the steady state, full-light operating resistance. If the full voltage were applied to a cold bulb at startup, the inrush bulb current could be ten times the rated current of the bulb, which could cause the bulb filament to weaken and ultimately break. By soft starting the control circuit, the voltage applied during starting of the bulb is significantly lower. As the bulb heats up and the bulb resistance increases, the voltage is increased. Thus the bulb current never exceeds its hot rating, which increases bulb life.

Soft starting of the circuit also helps reduce the inrush current from the circuit, thereby avoiding any interaction with other circuits or appliances. Soft starting in this circuit can be achieved by starting the driver IC21 at a high frequency and then reducing it to the normal operating frequency after a short delay, e.g. one second. This is possible because it is characteristic of this supply that higher switching frequencies tend to reduce supply output, causing the lamps to dim. A typical method for achieving soft starting is shown in FIG. 12. When the power supply is first turned on, voltage is applied to pin 1 (Vcc) of IC21, enabling it to operate. Voltage is also applied to resistor R93. This causes capacitor C96 to begin to charge up. During this time, transistor Q90 is ‘off’. The switching frequency of the supply is determined by the resistance between pins 2 and 3 of IC21 in combination with the capacitance from pin 3 to ground. Since the transistor Q90 is ‘off’, that capacitance is capacitor C30 in series with capacitor C95, which causes the supply to switch at a very high frequency and its output to be correspondingly low. The lights attached glow dimly. After about one second capacitor C96 charges up, causing transistor Q90 to turn on. Transistor Q90 and diode D95 now effectively short out capacitor C95 so that only capacitor C30 is left in the circuit. This causes the power supply to switch at a lower frequency, insuring normal lamp brightness. It should be understood that this is only one of many known methods of achieving the soft-start function.

If a wider range of dimming control is needed, the driver IC21 can be replaced by another integrated circuit, such as an IR21571, to drive the FETs, it is capable of providing pulse width modulation. The output can be controlled from low light to full light.

The particular embodiment illustrated in FIG. 12 is a half bridge circuit and a typical example, but it will be understood that the features of this circuit can be incorporated in other topologies such as flyback, forward, buck, full bridge or other power converters, including isolated as well as non-isolated power converter designs.

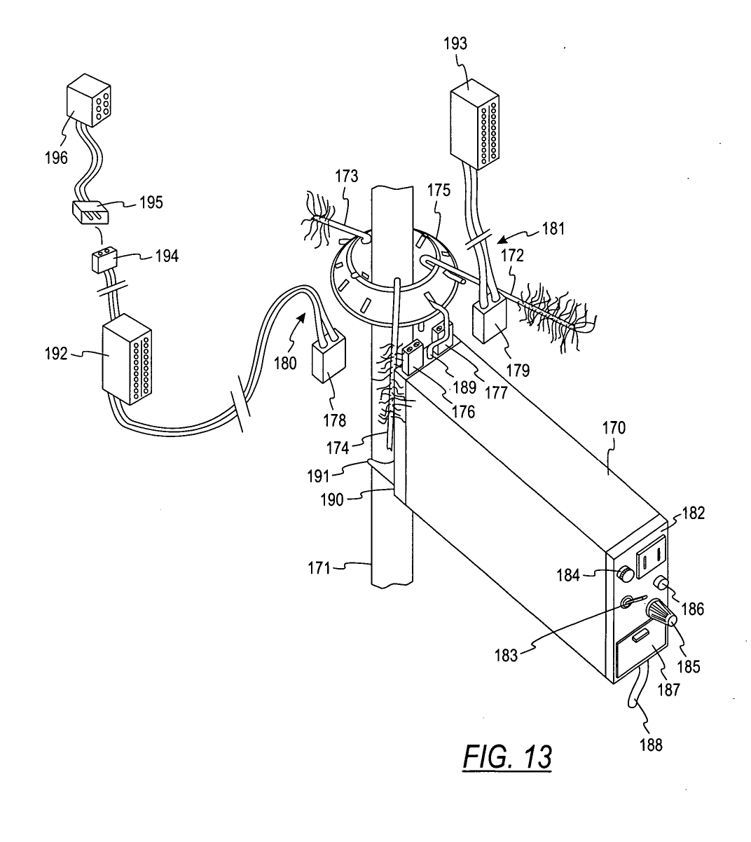

FIG. 13 illustrates a mounting arrangement for a housing 170 containing any of the power supplies described above, on a pre-lit artificial tree having a central “trunk” pole 171 and multiple branches such as branches 172-174 extending laterally from a support collar 175 on the pole 171. Each branch carries a portion of one of multiple light strings attached to connectors on the housing 170. In the illustrative embodiment, two such connectors 176 and 177 project upwardly from the top of the housing 170 for receiving mating connectors 178 and 179 attached to respective ends of two pairs of conductors 180 and 181. When the connectors 178 and 179 are mated to the connectors 176 and 177, the conductors are connected to the power supply contained within the housing 170.

In an artificial tree having two or more vertical sections, the power supply housing 170 is preferably mounted on the uppermost collar 175 in the lowest of the three sections. Then one of the two connectors 176, 177 can supply power to the lowest section(s) of the tree, which generally is(are) the largest section(s), while the other connector supplies power to the smaller, upper sections of the tree. The electrical loads in the light strings in these two portions of the tree are typically about equal, and thus the output of the power supply can be split evenly between the two output connectors 176, 177.

As can be seen in FIG. 13, the outer end panel 182 of the housing 170 is most accessible to the user. This end panel 182 carries a manually operated on-off switch 183 for turning the power supply on and off, and an indicator light 184 that is illuminated whenever the power supply is connected to a power source. A dimmer knob 185 connected to a potentiometer permits the user to control the light level by adjusting the position of the potentiometer. A bulb socket 186 permits the user to test a bulb by connecting the bulb to an appropriate power source within the housing. The panel 182 also contains a drawer 187 for storage of spare bulbs and fuses. Power for the circuitry within the housing 170 is supplied via cord 188.

To mount the housing 170 on the collar 175, a hook 189 extends upwardly from the housing. The weight of the housing 170 forces the lower end of the inside panel 190 against the pole 171, and a yoke 191 projecting from the inside panel keeps the housing centered on the pole.

The two pairs of conductors 180 and 181 are connected to respective connector blocks 192 and 193 each of which includes multiple connectors for receiving mating connectors crimped onto the ends of the wires of multiple light strings. For example, the connector block 193 typically receives the connectors on a multiplicity of light strings mounted on the bottom section(s) of a pre-lit tree. The other connector block 192 typically receives a multiplicity of light strings for the middle section of the tree. The top section(s) of the tree typically includes two or more light strings, which are connected to a smaller third connector block 196 connected to the block 192 via mating connectors 194 and 195 on the ends of two pairs of conductors leading to the respective blocks 192 and 196.

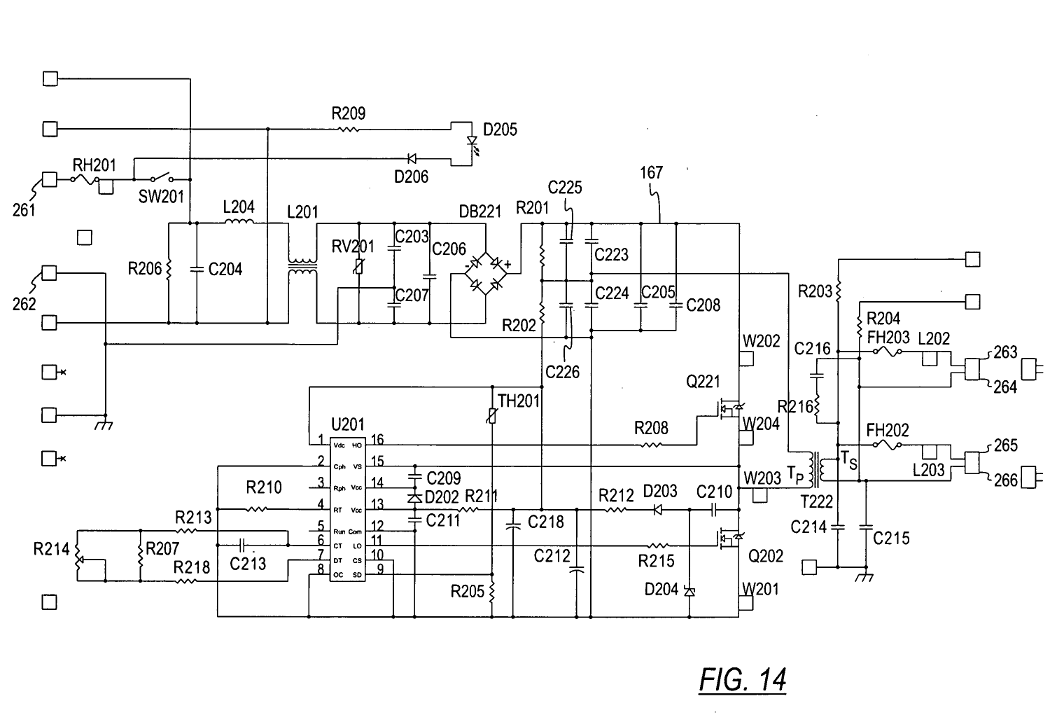

FIG. 14 is another schematic diagram of a power supply for converting a standard 120-volt, 60-Hz input at terminals 261, 262 into a 24-volt AC output at terminals 263, 264 and 265, 266. This circuit uses a switching power supply to deliver a low-voltage, high-frequency PAM signal while also providing the following features for the light strings:
continuous dimming capability from very low light level to full light level,
multi-level dimming capability,
energy-saving and minimum-light-setting features,
soft-start feature to increase the lamp life,
soft start feature to reduce inrush current in the circuit, and
low cost with multi-feature lighting.

The AC input from the terminals 261, 262 is supplied through a fuse FH201 to a diode bridge DB221 consisting of four diodes to produce a full-wave rectified output across buses 267 and 268, leading to a pair of capacitors C223 and C224 and a corresponding pair of transistors Q221 and Q222 forming a half bridge. The input to the diode bridge DB221 includes a passive component network consisting of C203, C204, C206, C207, L201, L204 and RV201 which are part of the radio frequency interference and line noise filtering circuitry. Capacitors C225 and C226 are connected in parallel with capacitors C223 and C224, respectively, to provide increased ripple current rating and high-frequency performance. The capacitors C223 and C224 may be electrolytic capacitors while capacitors C225 and C226 are film-type capacitors offering high-frequency characteristics to the parallel combination.

The capacitors C223, C224 form a virtual center tap. One end of the primary winding T_{P} of an output transformer T222 is connected to a point between the two capacitors. The secondary winding T_{S} of the transformer T222 is connected to the output terminals 263, 264 and 265, 266, through series inductors L202 and L203 (along with C214, C215, C216 and R216) which act as filters to minimize electromagnetic interference. The output terminals receive one or more plugs on the ends of light strings.

An integrated circuit driver U201, such as a IR21571D controller available from International Rectifier, controls the switching frequency of oscillation and other features indicated above. The power supply V_{cc} for the driver U201 is derived from the DC bus 267 through resistors R201 and R202 to an internal zener diode. The device includes protection elements which prohibit starting oscillation (operation) until the power supply voltages are in tolerance or if there is a fault which interferes with the proper sequencing of voltages V_{DC}, V_{CC}, and V_{SD}. Diodes D202, D203, D204 and capacitors C209, C210 and C211 provide a boot-strap mechanism for powering the IC. Capacitors C212 and C218 provide bulk storage to start the controller at power up.

The frequency of oscillation of the controller is determined by the total resistance connected between pin 12 (Corn) and pin 4 of the controller U201 and a capacitor C213 connected between pin 6 and pin 12 (Corn) of the controller U201. The two outputs of U201 at pins 11 and 16 are connected to the gates of the MOSFETs Q221 and Q222. A resistor R208 limits the gate current of the MOSFET Q221. A second resistor R215 limits the gate current of the MOSFET Q222.

When power is applied to the circuit, the voltage developed on the bus 267 causes voltage to be applied to U201 V_{CC}, V_{DC}, and SD. This causes U201 to start oscillating and start driving the half-bridge transistors Q221 and Q222 alternately. This applies voltage across the primary winding T_{P} of the transformer T222, which in turn applies voltage across the secondary winding T_{S} of the transformer, which is applied to the load.

The rectified output of the DC bus 267 is applied to the Vcc and V_{DC} pins of the controller U201 through resistors R201 and R202. An internal zener diode and capacitors C218 and C212 maintain the operating voltages for the controller. A voltage divider consisting of a thermistor TH201 and R205 sets the voltage at pin 9 (SD) of U201. The controller uses these three voltages to determine the state of the power bus 267 to prevent operation when the power bus has collapsed.

The preset output voltage is set by the turns ratio of the output transformer T222. A limited dimming control is achieved by adjusting the resistance that appears between pins 6 and 7 of controller U201. This resistance controls the amount of dead time for the output FETs, which reduces the RMS value of the output voltage of T222 and thereby reduces the intensity of the light strings connected to terminals 263, 264 and 265, 266

The dimming feature can be used to provide different fixed light levels, such as a low light output, an energy-saving output, or a full-light output. These three light levels can be achieved by use of three fixed resistors in place of the potentiometer R214. The three resistor settings can be selected by use of a three-position switch. A low-light output corresponds to a maximum output dead time, and a full-light output corresponds to minimum dead time. An energy-saving output corresponds to an intermediate light level such as a 75% light output.

The controller has an additional control pin (SD) which can be used as a thermal shutdown control to protect the power supply from overheating. As the air temperature in the unit rises, the value of TH201 will decline until the voltage appearing at pin 9 of U201 rises above the shut down value of approximately 2.0 volts.

The particular embodiment illustrated in FIG. 14 employs a half bridge circuit, but it will be understood that the features of this circuit can be incorporated in other topologies such as flyback, forward, buck, full bridge or other power converters, including isolated as well as non-isolated power converter designs.

While the present invention has been described with reference to one or more particular embodiments, those skilled in the art will recognize that many changes may be made thereto without departing from the spirit and scope of the present invention. Each of these embodiments and obvious variations thereof is contemplated as falling within the spirit and scope of the claimed invention, which is set forth in the following claims.

1. A string of decorative lights comprising
a power supply having an input adapted for connection to a standard residential electrical power outlet, the power supply including circuitry for converting the standard residential voltage to a low-voltage output, the input connected through a fusing device to a rectifier circuit,
a pair of conductors connected to the output of the power supply for supplying the low-voltage output to multiple decorative lights, and
multiple lights connected to the conductors along the lengths thereof, each of the lights, or groups of the lights, being connected in parallel across the conductors.

2. A string of decorative lights as set forth in claim 1 wherein each of the lights is about a half-watt bulb.

3. A string of decorative lights as set forth in claim 1 wherein each of the lights requires a voltage of about 12 volts or less.

4. A string of decorative lights as set forth in claim 1 wherein the lights are connected in parallel across the conductors in parallel groups of two to five lights per group, the lights within each group being connected in series.

5. A string of decorative lights as set forth in claim 1 wherein the standard residential voltage is 120 volts and approximately 52 6-volt lights are connected to the conductors.

6. A string of decorative lights as set forth in claim 1 wherein the low-voltage output is DC or AC.

7. A string of decorative lights as set forth in claim 1 wherein the rectifier circuit is a diode bridge.

8. A string of decorative lights as set forth in claim 1 wherein the low-voltage output is less than about 30 volts rms.

9. A string of decorative lights as set forth in claim 1 wherein the power supply comprises an electronic transformer.

10. A string of decorative lights as set forth in claim 1 wherein the power supply comprises a switching power supply.

11. A string of decorative lights as set forth in claim 1 wherein the power supply converts the standard residential frequency to a higher frequency output.

12. A string of decorative lights as set forth in claim 11 wherein the higher frequency is in the range from about 10 KHz to about 150 KHz.

13. A string of decorative lights as set forth in claim 1 wherein the conductors are connected to a fixed number of the lights so as to provide a fixed load on the power supply.

14. A string of decorative lights as set forth in claim 1 wherein each of the lights includes means for shunting the light in response to a failure of the light.

15. A decorative lighting system, the system comprising
a power supply having an input adapted for connection to a standard residential electrical power outlet, the power supply including circuitry for converting the standard residential voltage to a low-voltage output, the input connected through a fusing device to a rectifier circuit,
a plurality of pairs of conductors connected to the output of the power supply for supplying the low-voltage output to multiple sets of decorative lights, and
multiple lights connected to each pair of the conductors along the lengths thereof, each of the lights, or groups of the lights, being connected in parallel across each of the pairs of conductors.

16. A decorative lighting system as set forth in claim 15 wherein each of the lights is about a half-watt bulb.

17. A decorative lighting system as set forth in claim 15 wherein each of the lights requires a voltage or about 6 volts or less.

18. A decorative lighting system as set forth in claim 15 wherein each of the pairs of conductors has multiple groups of the lights connected in parallel across the conductor pair, each of the parallel groups including two to five lights connected in series within the group.

19. A decorative lighting system as set forth in claim 15 wherein the standard residential voltage is 120 volts and approximately 52 6-volt lights are connected to each of the pairs of conductors.

20. A decorative lighting system as set forth in claim 15 wherein the low-voltage output is DC.

21. A decorative lighting system as set forth in claim 15 wherein the low-voltage output is AC.

22. A decorative lighting system as set forth in claim 15 wherein the low-voltage output is less than about 30 volts rms.

23. A decorative lighting system as set forth in claim 15 wherein the power supply comprises an electronic transformer.

24. A decorative lighting system as set forth in claim 15 wherein the power supply comprises a switching power supply.

25. A decorative lighting system as set forth in claim 15 wherein the power supply converts the standard residential frequency to a higher frequency output.

26. A decorative lighting system as set forth in claim 25 wherein the higher frequency is in the range from about 10 KHz to about 150 KHz.

27. A decorative lighting system as set forth in claim 15 wherein each of the pairs of conductors is connected to a fixed number of the lights so as to provide a fixed load on the power supply.

28. A decorative lighting system as set forth in claim 15 wherein each of the lights includes means for shunting the light in response to a failure of the light.

29. A method of powering at least one string of decorative lights, the method comprising
converting a standard residential electrical voltage to a low-voltage, using a power supply having an input coupled through a fusing device to a rectifier circuit, and
supplying the low-voltage to a pair of parallel conductors having multiple decorative lights connected to the conductors along the lengths thereof, each of the lights, or groups of the lights, being connected in parallel across the conductors.

30. A method of powering a string of decorative lights as set forth in claim 29 wherein each of the lights is about a half-watt bulb.

31. A method of powering a string of decorative lights as set forth in claim 29 wherein each of the lights requires a voltage or about 6 volts or less.

32. A method of powering a string of decorative lights as set forth in claim 29 wherein the lights are connected in parallel across the conductors in parallel groups of two to five lights per group.

33. A method of powering a string of decorative lights as set forth in claim 29 wherein the standard residential voltage is 120 volts and approximately 52 6-volt lights are connected to the conductors.

34. A method of powering a string of decorative lights as set forth in claim 29 wherein the low-voltage output is DC.

35. A method of powering a string of decorative lights as set forth in claim 29 wherein the low-voltage output is AC.

36. A method of powering a string of decorative lights as set forth in claim 29 wherein the low-voltage output is less than about 30 volts rms.

37. A method of powering a string of decorative lights as set forth in claim 29 wherein an electronic transformer is used in the conversion of the standard residential electrical voltage to a low voltage.

38. A method of powering a string of decorative lights as set forth in claim 29 wherein a switching power supply is used in the conversion of the standard residential electrical voltage to a low voltage.

39. A method of powering a string of decorative lights as set forth in claim 29 wherein the standard residential frequency is converted to a higher frequency output.

40. A method of powering a string of decorative lights as set forth in claim 39 wherein the higher frequency is in the range from about 10 KHz to about 150 KHz.

41. A method of powering a string of decorative lights as set forth in claim 29 wherein a fixed load is maintained on the conductors by limiting the number of lights connected to the conductors to a fixed number.

42. A method of powering a string of decorative lights as set forth in claim 29 which includes the step of shunting each of the lights in response to a failure of that light.

43. A string of decorative lights comprising
a power source for providing current,
switch circuitry coupled to the power source, and
multiple lights connected to the power source, each of the lights, or groups of the lights, being connected with the switch circuitry, wherein the switch circuitry is adapted to manipulate the appearance of the multiple lights.

44. A string of decorative lights as set forth in claim 43 wherein the manipulation of the appearance of the multiple lights comprise changing the color of the lights, causing the lights to blink, or a combination thereof.

45. A string of decorative lights as set forth in claim 43 wherein the power source includes low-voltage circuitry for converting the standard residential voltage to a low-voltage output.

46. A string of decorative lights as set forth in claim 43 wherein the lights are connected in parallel across the switch circuitry in parallel groups of two to fifty lights per group, the lights within each group being connected in series.

47. A string of decorative lights as set forth in claim 45 wherein the standard residential voltage is 120 volts and approximately 52 6-volt lights are connected to the switch circuitry.

48. A string of decorative lights as set forth in claim 45 wherein the low-voltage output is DC.

49. A string of decorative lights as set forth in claim 45 wherein the low-voltage output is AC.

50. A string of decorative lights as set forth in claim 45 wherein the low-voltage output is less than about 30 volts rms.

51. A string of decorative lights as set forth in claim 43 wherein the power source comprises an electronic transformer.

52. A string of decorative lights as set forth in claim 43 wherein the power source comprises a switching power supply.

53. A string of decorative lights as set forth in claim 43 wherein the power source converts the standard residential frequency to a higher frequency output.

54. A string of decorative lights as set forth in claim 53 wherein the higher frequency is in the range from about 10 KHz to about 150 KHz.

55. A string of decorative lights as set forth in claim 43 wherein the switch circuitry is connected to a fixed number of the lights so as to provide a fixed load on the power source.

56. A string of decorative lights as set forth in claim 43 wherein each of the lights includes means for shunting the light in response to a failure of the light.

57. A string of decorative lights as set forth in claim 43, further comprising a reversible plug connected to the output of the power source, the reversible plug being able to be inserted into the output in either of two orientations, and wherein the reversible plug allows for different decorative effects to be achieved depending on the orientation of the reversible plug in the outlet of the power source.

58. A string of decorative lights as set forth in claim 57, wherein the different decorative effects comprise a color change, blinking lights, or a combination thereof.

59. A string of decorative lights as set forth in claim 57, wherein the light string comprises a plurality of sockets, each of the plurality of sockets containing two separate bulbs, and the plug supplies current to only one depending on the orientation of the reversible plug in the outlet, allowing for different decorative effects.

60. A string of decorative lights as set forth in claim 57, wherein the light string comprises a plurality of sockets, each of the plurality of sockets containing one bulb, and each bulb containing two filaments, wherein current is only supplied to one of the filaments, depending on the orientation of the reversible plug in the outlet, allowing for different decorative effects.

61. A string of decorative lights as set forth in claim 43, wherein the switching circuitry includes a mechanical switch coupled to the power source, the mechanical switch being able to switch the direction of the current flow, allowing for different decorative effects to be achieved.

62. A string of decorative lights as set forth in claim 61, wherein the light string comprises a plurality of sockets, each of the plurality of sockets containing two separate bulbs, and the mechanical switch allows current to flow to only one of the two separate bulbs depending on the orientation of the mechanical switch, allowing for different decorative effects.

63. A string of decorative lights as set forth in claim 61, wherein the light string comprises a plurality of sockets, each of the plurality of sockets containing one bulb, and each bulb containing two filaments, wherein current is only supplied to one of the filaments, depending on the orientation of the mechanical switch, allowing for different decorative effects.

64. A string of decorative lights as set forth in claim 43, wherein either the power supply or the switch circuitry is adapted to convert the AC current to DC current and to control the direction, amplitude or interval of the DC current through the multiple lights.

65. A string of decorative lights as set forth in claim 43, wherein the switch circuitry comprises at least one switch adapted to allow only a predetermined portion of the AC current to go through the multiple lights.

66. A string of decorative lights as set forth in claim 43, wherein the switching circuitry includes electronic switch circuitry coupled to the power source, the electronic switch circuitry being able to switch the direction, amplitude, or interval of the current flow, allowing for different decorative effects to be achieved.

67. A string of decorative lights as set forth in claim 66, wherein the light string comprises a plurality of sockets, each of the plurality of sockets containing two separate bulbs, and the electronic switch circuitry allows current to flow to only one or neither of the two separate bulbs depending on the orientation of the electronic switch circuitry, allowing for different decorative effects.

68. A string of decorative lights as set forth in claim 66, wherein the light string comprises a plurality of sockets, each of the plurality of sockets containing one bulb, and each bulb containing two filaments, wherein current is only supplied to one or neither of the filaments, depending on the orientation of the electronic switch circuitry, allowing for different decorative effects.

69. A string of decorative lights as set forth in claim 66, wherein the electronic switch circuitry includes at least one of a TRIAC, DIAC, SCR, diode, or a transistor.

70. A string of decorative lights as set forth in claim 43, wherein the switch circuitry, power source, or combination thereof is adapted to convert the AC current to DC current and to control the direction of the DC current through the multiple lights.

71. A string of decorative lights as set forth in claim 43, wherein the switch circuitry comprises a switch adapted to allow only predetermined portions of the AC current to go through the multiple lights.

72. A string of decorative lights comprising
a first power source,
a second power source connected to the first power source, and
multiple lights connected to the first and second power sources, wherein the first and second power supplies are adapted to manipulate the appearance of the multiple lights.

73. A string of decorative lights as set forth in claim 72 wherein each of the lights is about a half-watt bulb.

74. A string of decorative lights as set forth in claim 72 wherein the first power source includes low-voltage circuitry for converting the standard residential voltage to a low-voltage output.

75. A string of decorative lights as set forth in claim 72 wherein the first power source is an AC power source and the second power source is a lower frequency AC power source.

76. A string of decorative lights as set forth in claim 72 wherein the first power source is an AC power source and the second power source is a DC power source.

77. A string of decorative lights as set forth in claim 72 wherein at least one of the first and second power sources comprises an electronic transformer.

78. A string of decorative lights as set forth in claim 72 wherein at least one of the first and second power sources comprises a switching power supply.

79. A string of decorative lights as set forth in claim 72 wherein the first and second power sources are connected to a fixed number of the lights so as to provide a fixed load on the first and second power sources.

80. A string of decorative lights as set forth in claim 72 wherein each of the lights includes means for shunting the light in response to a failure of the light.

81. A string of decorative lights as set forth in claim 72, wherein first and second power sources are coupled so as to alter the amount and direction of current directed through the light string, allowing for different decorative effects to be achieved.

82. A string of decorative lights as set forth in claim 81, wherein the different decorative effects comprise a color change, blinking lights, or a combination thereof.

83. A string of decorative lights as set forth in claim 81, wherein the light string comprises a plurality of sockets, each of the plurality of sockets containing two separate bulbs, and the first and second power sources supply current to only one, allowing for different decorative effects.

84. A string of decorative lights as set forth in claim 81, wherein the light string comprises a plurality of sockets, each of the plurality of sockets containing two separate bulbs, and the first and second power sources supply differing amounts of current to each of the two separate bulbs, allowing for different decorative effects.

85. A string of decorative lights as set forth in claim 81, wherein the light string comprises a plurality of sockets, each of the plurality of sockets containing one bulb, and each bulb containing two filaments, wherein current is only supplied to one of the filaments, allowing for different decorative effects.

86. A string of decorative lights as set forth in claim 81, wherein the light string comprises a plurality of sockets, each of the plurality of sockets containing one bulb, and each bulb containing two filaments, wherein differing amounts of current is supplied to each of the filaments, allowing for different decorative effects.

87. A string of decorative lights comprising
an AC power supply having an input adapted for connection to a standard residential electrical power outlet, the standard residential electrical power outlet providing AC current,
a rectifier coupled to the AC power supply for generating two DC power sources,
switch circuitry coupled to the rectifier and including at least one switch, and
multiple lights connected to the switch circuitry, each of the lights, or groups of the lights, being connected with the switch circuitry, wherein the switch circuitry is adapted to manipulate the appearance of the multiple lights.

88. A string of decorative lights as set forth in claim 87 wherein each of the lights is about a half-watt bulb.

89. A string of decorative lights as set forth in claim 87 wherein the lights are connected in parallel across the switch circuitry in parallel groups of two to fifty lights per group, the lights within each group being connected in series.

90. A string of decorative lights as set forth in claim 87 wherein the standard residential voltage is 120 volts and approximately 52 6-volt lights are connected to the switch circuitry.

91. A string of decorative lights as set forth in claim 87 wherein the switch circuitry is connected to a fixed number of the lights so as to provide a fixed load on the power source.

92. A string of decorative lights as set forth in claim 87 wherein each of the lights includes means for shunting the light in response to a failure of the light.

93. A string of decorative lights as set forth in claim 87, wherein the switch circuitry is adapted to provide the function of a single pole triple throw electronic switch.

94. A string of decorative lights as set forth in claim 87, wherein the switch circuitry alters the current flow, allowing for different decorative effects to be achieved.

95. A string of decorative lights as set forth in claim 94, wherein the different decorative effects comprise a color changes, blinking lights or a combination thereof.

96. A string of decorative lights as set forth in claim 94, wherein the light string comprises a plurality of sockets, each of the plurality of sockets containing two separate bulbs, and the switch circuitry supplies differing amounts of current to each bulb, allowing for different decorative effects.

97. A string of decorative lights as set forth in claim 94, wherein the light string comprises a plurality of sockets, each of the plurality of sockets containing one bulb, and each bulb containing two filaments, wherein the switch supplies differing amounts of current to each of the filaments, allowing for different decorative effects.

98. A string of decorative lights comprising
an AC power supply having an input adapted for connection to a standard residential electrical power outlet, the standard residential electrical power outlet providing AC current,
first switch circuitry coupled to the AC power supply and including a switch,
second switch circuitry coupled to the AC power supply and including a switch, the first switch circuitry being in an on position when the second switch circuitry is in an off position, the first switch circuitry being in an off position when the second switch circuitry is in an on position, or both the first and second switch circuitry being in an off position, and
multiple lights connected to the first and second switching circuits, wherein the manipulation of the current by altering the percentage that the first switch circuitry is on relative to the second switch circuitry alters the appearance of the multiple lights.

99. A string of decorative lights as set forth in claim 98 wherein each of the lights is about a half-watt bulb.

100. A string of decorative lights as set forth in claim 98 wherein the power source, switch circuitry, or both comprises a TRIAC, DIAC, an SCR, or other electronic switching circuitry.

101. A string of decorative lights as set forth in claim 98 wherein the switch circuitry is connected to a fixed number of the lights so as to provide a fixed load on the power source.

102. A string of decorative lights as set forth in claim 98 wherein each of the lights includes means for shunting the light in response to a failure of the light.

103. A string of decorative lights as set forth in claim 98, wherein the manipulation of the current allows for different decorative effects to be achieved.

104. A string of decorative lights as set forth in claim 103, wherein the different decorative effects comprise a color changes, blinking lights, or a combination thereof.

105. A string of decorative lights as set forth in claim 98, wherein the light string comprises a plurality of sockets, each of the plurality of sockets containing two separate bulbs, and the amount of current supplied to the two separate bulbs is altered, allowing for different decorative effects.

106. A string of decorative lights as set forth in claim 98, wherein the light string comprises a plurality of sockets, each of the plurality of sockets containing one bulb, and each bulb containing two filaments, wherein the amount of current supplied to each of the filaments is altered, allowing for different decorative effects.

107. A method for manipulating lights on a string of decorative lights comprising
providing a power source providing current,
providing switching circuitry coupled to the power source with at most two wires, and
altering the switching circuitry in order to manipulate the current in order to alter the appearance of multiple lights connected to the power source.

108. The method of claim 107 further comprising converting the standard residential voltage to a low-voltage output.

109. The method of claim 107 wherein the step of supplying the power source comprises converting the standard residential frequency to a higher frequency output.

110. The method of claim 107 wherein the switching is performed by switch circuitry and the method further comprises providing a fixed load on the power source by connecting the switch circuitry to a fixed number of the lights so as to provide a fixed load on the power source.

111. The method of claim 107 further comprising shunting one of the multiple lights in response to a failure of the one of the multiple lights.

112. The method of claim 107, wherein the manipulation of the switching circuitry allows for different decorative effects to be achieved.

113. The method of claim 112, wherein the different decorative effects comprise a color change, blinking lights, or a combination thereof.

114. The method of claim 112, wherein the light string comprises a plurality of sockets, each of the plurality of sockets containing two separate bulbs, and the method comprising supplying current to only one of the two bulbs, depending on the orientation of the switching circuitry, allowing for different decorative effects.

115. The method of claim 112, wherein the light string comprises a plurality of sockets, each of the plurality of sockets containing one bulb, and each bulb containing two filaments, the method further comprising only supplying current to one of the filaments, depending on the orientation of the switching circuitry, allowing for different decorative effects.

116. The method of claim 107, wherein the switching circuitry includes a mechanical switch coupled to the power source, the method further comprising switching the direction of the current flow, via the mechanical switch, allowing for different decorative effects to be achieved.

117. The method of claim 116, wherein the light string comprises a plurality of sockets, each of the plurality of sockets containing two separate bulbs, and the method comprising allowing current to flow to only one of the two separate bulbs, depending on the orientation of the mechanical switch, allowing for different decorative effects.

118. The method of claim 116, wherein the light string comprises a plurality of sockets, each of the plurality of sockets containing one bulb, and each bulb containing two filaments, the method further comprising supplying current to one of the filaments, depending on the orientation of the mechanical switch, allowing for different decorative effects.

119. The method of claim 107, wherein the step of altering the switch circuitry includes allowing only a predetermined portion of the AC current to go through the multiple lights.

120. The method of claim 107, wherein the switching circuitry includes at least one electronic switch coupled to the power source, the method further comprising switching the direction, amplitude, and interval of the current flow, via the electrical switch, allowing for different decorative effects to be achieved.

121. The method of claim 120, wherein the light string comprises a plurality of sockets, each of the plurality of sockets containing two separate bulbs, and the switching of the at least one electronic switch includes allowing current to flow to only one or neither of the two separate bulbs depending on the orientation of the at least one electronic switch, allowing for different decorative effects.

122. The method of claim 120, wherein the light string comprises a plurality of sockets, each of the plurality of sockets containing one bulb, and each bulb containing two filaments, wherein the step of switching the at least one electronic switch includes supplying current to only one or neither of the filaments, depending on the orientation of the at least one electronic switch, allowing for different decorative effects.

123. The method of claim 107, further comprising converting an AC current to DC current and controlling the direction of the DC current through the multiple lights.

124. The method of claim 107, the altering step including allowing only a predetermined portion of the current to go through the multiple lights.

125. A method for manipulating lights on a string of decorative lights comprising
providing a first power source providing current,
providing a second power source coupled to the first power source, and
controlling the output of the first and second power sources in order to manipulate the current in order to alter the appearance of multiple lights connected to the first and second power sources, creating different decorative effects.

126. The method of claim 125 wherein the first power source is an AC power source and the second power source is a lower frequency AC power source.

127. The method of claim 125 wherein the first power source is an AC power source and the second power source is a DC power source.

128. The method of claim 125, wherein the different decorative effects comprise a color change, blinking lights, or a combination thereof.

129. The method of claim 125, wherein the light string comprises a plurality of sockets, each of the plurality of sockets containing two separate bulbs, and the method comprising supplying current to only one of the bulbs, allowing for different decorative effects.

130. The method of claim 125, wherein the light string comprises a plurality of sockets, each of the plurality of sockets containing two separate bulbs, and the method comprising supplying differing amounts of current via the first and second power sources, to each of the two separate bulbs, allowing for different decorative effects.

136. The method of claim 125, wherein the light string comprises a plurality of sockets, each of the plurality of sockets containing one bulb, and each bulb containing two filaments, wherein the controlling step includes supplying current, via the first and second power sources, to only one of the filaments, allowing for different decorative effects.

137. The method of claim 125, wherein the light string comprises a plurality of sockets, each of the plurality of sockets containing one bulb, and each bulb containing two filaments, wherein the step of controlling comprises supplying differing amounts of current to each of the filaments, via the first and second power sources, allowing for different decorative effects.

138. A method for manipulating lights on a string of decorative lights comprising
providing an AC power source providing current,
providing a rectifier coupled to the AC power supply for generating two DC power sources,
providing switching circuitry coupled to the rectifier, and
altering the switching circuitry in order to manipulate the current in order to alter the appearance of multiple lights connected to the power source.

139. The method of claim 138, wherein the switch circuitry functions as a single pole triple throw electronic switch.

140. The method of claim 138, wherein the light string comprises a plurality of sockets, each of the plurality of sockets containing two separate bulbs, wherein the step of altering the switching circuitry includes supplying differing amounts of current to each bulb, allowing for different decorative effects.

141. The method of claim 138, wherein the light string comprises a plurality of sockets, each of the plurality of sockets containing one bulb, and each bulb containing two filaments, wherein the step of altering the switching circuitry includes supplying differing amounts of current to each of the filaments, allowing for different decorative effects.

142. A method for manipulating lights on a string of decorative lights comprising
providing an AC power source providing current,
providing first switch circuitry coupled to the AC power supply and including a switch,
providing second switch circuitry coupled to the AC power supply and including a switch, the first switch circuitry being in an on position when the second switch circuitry is in an off position, the first switch circuitry being in an off position when the second switch circuitry is in an on position, or both the first and second switch circuitry being in an off position, and
altering the switching circuitry in order to manipulate the percentage that the first switch circuitry is on relative to the second switch circuitry alters the appearance of the multiple lights.

143. The method of claim 142, wherein the light string comprises a plurality of sockets, each of the plurality of sockets containing two separate bulbs, wherein the altering step includes altering the amount of current supplied to the two separate bulbs, allowing for different decorative effects.

144. The method of claim 142, wherein the light string comprises a plurality of sockets, each of the plurality of sockets containing one bulb, and each bulb containing two filaments, wherein the step of altering includes altering the amount of current supplied to each of the filaments, allowing for different decorative effects.

145. A string of decorative lights comprising:
a plurality of elongated electrical conductors having multiple electrical lamps inserted into sockets connected thereto at intervals along the lengths of the conductors, and
a small compartment, the compartment including a wall forming a first opening adapted to receive in frictional engagement a base of an electrical lamp, the compartment also including a first member adapted to engage a second member on the socket.

146. The string of decorative lights of claim 145 wherein the first member is a first ramp and the second member is a second ramp, the first ramp being designed to engage a second ramp on the socket to assist in removing the electrical lamp from the socket.

147. A method of removing failed bulbs in a string of decorative lights, the method comprising:
providing a small compartment, the compartment including a wall forming a first opening,
pressing the opening between a top surface of a socket holding a bulb and the bulb,
twisting the small compartment to loosen the bulb in the socket,
removing the bulb from the socket, and
attaching the compartment to the string of decorative lights so that the opening is conveniently accessible when needed to replace a component in the light string.

148. A string of decorative lights comprising
a power source for providing current, and
multiple lights connected to the power source, each of the lights comprising a socket containing one bulb, and each bulb containing two filaments, and a diode connected to each filament, such that when current is supplied to the socket, only one of the filaments receives current, depending on the direction of the current, allowing for different decorative effects.

149. A string of decorative lights comprising
a power source for providing current, and
multiple lights connected to the power source, each of the lights comprising a socket containing two bulbs, and each bulb containing one filament, and a diode connected to each of the two bulbs, such that when current is supplied to the socket, only one of the bulbs receives current, depending on the direction of the current, allowing for different decorative effects.
